(19) United States
(12) Patent Application Publication
(10) Pub. No.: US 2026/0267759 A1
(43) Pub. Date: Sep. 10, 2026

(54) METHOD, APPARATUS, DEVICE, AND PRODUCT FOR DETERMINING SMOOTHNESS

(71) Applicant: Beijing Zitiao Network Technology Co., Ltd., Beijing (CN)

(72) Inventors: Tao YU, Beijing (CN); Ruiyan LI, Beijing (CN); Yibo YUAN, Beijing (CN)

(21) Appl. No.: 19/559,426

(22) Filed: Mar. 6, 2026

(30) Foreign Application Priority Data
Mar. 10, 2025 (CN) 202510279657.4

(51) Int. Cl. G06F 11/30; G06F 11/34; G09G 5/393

(52) U.S. Cl. CPC G06F 11/302; G06F 11/3485; G09G 5/393; G09G 2340/0435

(57) ABSTRACT

The present disclosure relates to a method, an apparatus, a device, and a product for determining smoothness. The method includes determining a first number of drawn frames and a dropped frame number for dropped frames associated with a user interface (UI) within a preset time period. The method further includes determining a second frame number of frames that should be drawn within the preset time period based on a duration of the preset time period and a preset UI refresh rate. The method further includes determining a drawing percent for indicating weights of the drawn frames and the dropped frames based on the first frame number, the dropped frame number, and the second frame number. The method further includes determining smoothness of the UI based on the first frame number, the dropped frame number, and the drawing percent.

### CROSS-REFERENCE TO RELATED APPLICATION(S)

This application claims priority to Chinese Application No. 202510279657.4 filed in Mar. 10, 2025, the disclosure of which is incorporated herein by reference in its entity.

### FIELD

The present disclosure relates to the field of computers and, in particular, to a method, an apparatus, a device, and a product for determining smoothness.

### BACKGROUND

With the rapid development of electronic technologies, designs of user interfaces (UIs) become increasingly complex and sophisticated, and smoothness in user experience has become one of the key indicators for measuring performance of applications or systems. Smoothness is directly related to satisfaction and comfort of users in interaction operations, and directly affects overall evaluations of users on products. At present, the related art generally uses frames per second (fps) to measure smoothness. A higher fps value represents a faster picture update, and users may experience smoother and more coherent operation effects in visual perception.

As an indicator for measuring UI smoothness, fps represents the number of frames that a system may process and display per second, and is a direct standard for measuring an image update speed. In a high-performance UI, a high fps value means a faster image refresh rate and less picture delay, thereby providing users with a smoother and stutter-free visual experience. With increasing requirements of users for interaction experience, optimizing fps performance and ensuring UI smoothness have become important issues.

### SUMMARY

A first aspect of embodiments of the present disclosure provides a method for determining smoothness. The method includes determining a first frame number of drawn frames and a dropped frame number for dropped frames associated with a user interface (UI) within a preset time period. The method further includes determining a second frame number of frames that should be drawn within the preset time period based on a duration of the preset time period and a preset UI refresh rate. The method further includes determining a drawing percent for indicating weights of the drawn frames and the dropped frames based on the first frame number, the dropped frame number, and the second frame number. In addition, the method further includes determining smoothness of the UI based on the first frame number, the dropped frame number, and the drawing percent.

A second aspect of embodiments of the present disclosure provides an apparatus for determining smoothness. The apparatus includes a first frame number determination module configured to determine a first frame number of drawn frames and a dropped frame number for dropped frames associated with a user interface (UI) within a preset time period. The apparatus further includes a second frame number determination module configured to determine a second frame number of frames that should be drawn within the preset time period based on a duration of the preset time period and a preset UI refresh rate. The apparatus further includes a drawing percent determination module configured to determine a drawing percent for indicating weights of the drawn frames and the dropped frames based on the first frame number, the dropped frame number and the second frame number. In addition, the apparatus further includes a smoothness determination module configured to determine smoothness of the UI based on the first frame number, the dropped frame number, and the drawing percent.

A third aspect of embodiments of the present disclosure provides an electronic device. The electronic device includes one or more processors; and a storage for storing one or more programs, the one or more programs, when executed by the one or more processors, causing the one or more processors to implement a method for determining smoothness. The method includes determining a first frame number of drawn frames and a dropped frame number for dropped frames associated with a user interface (UI) within a preset time period. The method further includes determining a second frame number of frames that should be drawn within the preset time period based on a duration of the preset time period and a preset UI refresh rate. The method further includes determining a drawing percent for indicating weights of the drawn frames and the dropped frames based on the first frame number, the dropped frame number, and the second frame number. In addition, the method further includes determining smoothness of the UI based on the first frame number, the dropped frame number, and the drawing percent.

A fourth aspect of embodiments of the present disclosure provides a computer program product. The computer program product is tangibly stored on a non-transitory computer-readable medium and includes machine-executable instructions, the machine-executable instructions, when executed, causing a machine to implement a method for determining smoothness. The method includes determining a first frame number of drawn frames and a dropped frame number for dropped frames associated with a user interface (UI) within a preset time period. The method further includes determining a second frame number of frames that should be drawn within the preset time period based on a duration of the preset time period and a preset UI refresh rate. The method further includes determining a drawing percent for indicating weights of the drawn frames and the dropped frames based on the first frame number, the dropped frame number, and the second frame number. In addition, the method further includes determining smoothness of the UI based on the first frame number, the dropped frame number, and the drawing percent.

The Summary section is provided to introduce a selection of concepts in a simplified form, which will be further described in the Detailed Description section below. The Summary section is not intended to identify key features or essential features of the claimed subject matter, nor is it intended to limit the scope of the claimed subject matter.

### BRIEF DESCRIPTION OF THE DRAWINGS

The above and other features, advantages, and aspects of embodiments of the present disclosure will become more apparent in combination with the drawings and with reference to the following detailed description. In the drawings, the same or similar reference numerals represent the same or similar elements, where:

FIG. 1 shows a schematic diagram of an example environment in which multiple embodiments of the present disclosure may be implemented;

FIG. 2 shows a flowchart of a method for determining smoothness according to some embodiments of the present disclosure;

FIG. 3 shows a flowchart of a method for calculating the dropped frame number according to some embodiments of the present disclosure;

FIG. 4 shows a schematic diagram of a sampling interval according to some embodiments of the present disclosure;

FIG. 5 shows a flowchart of a method for determining fps during a sampling period according to some embodiments of the present disclosure;

FIG. 6 shows a block diagram of an apparatus for determining smoothness according to some embodiments of the present disclosure; and

FIG. 7 shows a block diagram of a device capable of implementing multiple embodiments of the present disclosure.

### DETAILED DESCRIPTION OF EMBODIMENTS

It may be understood that all user-related data involved in the technical solution should be obtained and used after user authorization. This means that in the technical solution, if it is necessary to use personal information of a user, explicit consent and authorization of the user are required before the data is obtained, otherwise, related data collection and use will not be performed. It should also be understood that when implementing the technical solution, relevant laws and regulations should be strictly complied with in a process of data collection, use, and storage, and necessary technical means and measures should be taken to ensure user data security and secure use of data.

It may be understood that before the technical solutions disclosed in embodiments of the present disclosure are used, users should be informed of the type, range of use, use scenarios, etc., of personal information involved in the present disclosure and authorization of the users should be obtained in an appropriate manner in accordance with relevant laws and regulations.

For example, when an active request of a user is received, prompt information is sent to the user to clearly prompt the user that the requested operation will require access to and use of personal information of the user. In this way, the user may independently choose, based on the prompt information, whether to provide the personal information to software or hardware, such as an electronic device, an application, a server, or a storage medium, that performs operations of the technical solutions of the present disclosure.

As an optional but non-limiting implementation, in response to receiving the active request of the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure, and other manners that satisfy the relevant laws and regulations may also be applied in the implementations of the present disclosure.

Hereinafter, embodiments of the present disclosure will be described in more detail with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only used for exemplary purposes, and are not used to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The terms “first”, “second”, etc. may refer to different or same objects, unless explicitly stated. Other explicit and implicit definitions may also be included below.

As described above, fps is an indicator for measuring UI smoothness. In the related art, a method for calculating fps is to continuously detect a time interval between every two frames. The method is implemented by a callback function (postFrameCallback) that is invoked after each frame is drawn. The callback function may feedback the time interval between two frames, so as to determine whether there is a picture dropped phenomenon and estimate fps. However, the method has some defects. First, since the callback function activates a vertical synchronization (vsync) mechanism when triggered, a frame rate is displayed higher, and calculated smoothness also lacks authenticity in case of inflated fps. Second, due to the influence of the vsync mechanism, the method is currently mainly limited to monitoring applications when sliding the screen.

Another method for monitoring smoothness is to directly measure the time of each rendering by the system. In the method, fps and the dropped frame number are obtained by calculating the time consumed for each rendering. However, the method records and reports only when there is a drawing task, resulting in that the obtained fps value only represents the condition when the drawing task is performed, and cannot fully reflect the real smoothness in the whole application running process.

To this end, the present disclosure provides a method for determining smoothness. First, a first frame number of drawn frames and a dropped frame number for dropped frames associated with a user interface (UI) within a preset time period are determined, and a second frame number of frames that should be drawn within the preset time period is determined based on a duration of the preset time period and a preset UI refresh rate. Then, a drawing percent for indicating weights of the drawn frames and the dropped frames is calculated based on the determined first frame number of drawn frames, the dropped frame number, and the second frame number. Finally, smoothness of the UI is determined based on the first frame number of drawn frames, the dropped frame number, and the drawing percent. In this way, not only the frame rate during the drawing task, but also the frame rate during the non-drawing period is considered by introducing the drawing percent, so that the overall frame rate during the application running process may be reflected more comprehensively and accurately, and the accuracy of smoothness evaluation is improved.

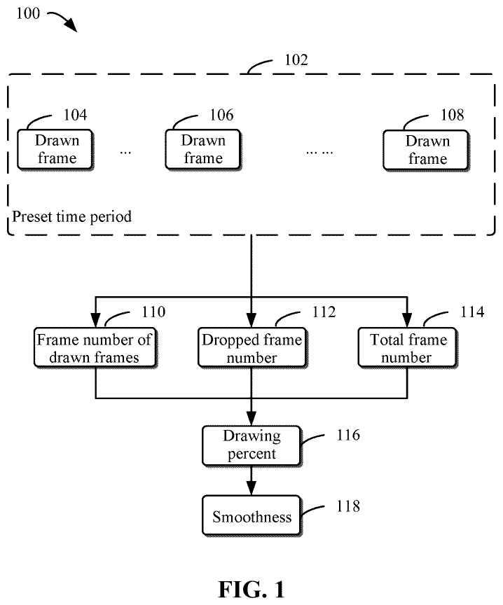

FIG. 1 shows a schematic diagram of an example environment 100 in which multiple embodiments of the present disclosure may be implemented. It should be understood that pictures of the UI are displayed in frames, and when the system receives a vsync signal including a drawing request, a graphics processing unit (GPU) of a client device may draw a new frame based on the latest data. Generally, the smoothness of the UI is related to its refresh rate, and the refresh rate is the number of times the screen is refreshed per second, which determines the frequency of image updates. Based on the refresh rate, a duration of each frame image on the UI per second and a time threshold for drawing a frame image may be calculated. When the actual drawing of a frame image exceeds the time threshold, a dropped frame will occur, thus reducing the smoothness of the UI.

In some embodiments, the smoothness of the UI may be determined by collecting and analyzing frame drawing information of the system. As shown in FIG. 1, there may be multiple drawing periods within a preset time period 102, and each drawing period corresponds to one drawn frame, for example, a drawn frame 104, a drawn frame 106, and a drawn frame 108. The preset time period 102 may be a time period for collecting the drawing information, and the smoothness condition of the UI within the preset time period 102 may be determined by analyzing the collected drawing information. In the embodiment of the present disclosure, a frame number of drawn frames 110 and the dropped frame number 112 may be determined based on information of the drawn frame 104, the drawn frame 106, and the drawn frame 108. The dropped frame number 112 may be determined based on the drawing duration of each drawn frame. For example, when the drawing durations of the drawn frame 104 and the drawn frame 106 are within the time threshold, but the drawing duration of the drawn frame 108 exceeds the time threshold, it means that the drawn frame 108 cannot be displayed on the UI at a desired time point and has to wait for the next opportunity. This situation will result in that one frame corresponding to the drawn frame 108 cannot be displayed, and it may be determined that the dropped frame number 112 within the preset time period 102 is 1, and the frame number of drawn frames 110 is 3. Certainly, the dropped frame number 112 may also be determined based on a load of the GPU or a central processing unit (CPU), an analysis of a rendering pipeline, or user feedback data, and a specific method for determining the dropped frame number 112 may be selected according to actual needs, which is not limited in the present disclosure.

As shown in FIG. 1, there may be a time interval between adjacent drawn frames within the preset time period 102, and when the system is not within the time interval for drawing, the UI will display the same image as the drawn frame that has been displayed. For example, during the time period between the drawn frame 104 and the drawn frame 106, the UI will display the image corresponding to the drawn frame 104. During the time period between the drawn frame 106 and the drawn frame 108, the UI will display the image corresponding to the drawn frame 106. Therefore, although there are only three drawn frames within the preset time period 102, the UI will actually display images of more frames according to the set refresh rate. In the embodiment of the present disclosure, a total frame number 114 may be determined based on the duration of the preset time period 102 and the set UI refresh rate. For example, the UI refresh rate is 60, that is, 60 frames will be displayed on the UI within 1s, and the duration of the preset time period 102 is 2s, then the total frame number 114 is 120 frames. The total frame number 114 indicates the maximum number of frames that may be displayed within the duration of the preset time period 102, that is, the maximum number of frames that should be drawn theoretically.

In some embodiments, after the frame number of drawn frames 110, the dropped frame number 112, and the total frame number 114 are determined, a drawing percent 116 may be determined, and then smoothness 118 may be determined based on the drawing percent 116, the frame number of drawn frames 110, and the dropped frame number 112. The drawing percent 116 is used to measure the weight of the frame number of drawn frames 110, that is, the frame number of successfully drawn frames and the dropped frame number 112 in the total frame number 114. Through the drawing percent 116, the influence of the frame rate during the drawing period on the overall frame rate may be measured, that is, the drawing percent 116 may help distinguish the importance of the frame rate during the drawing period and the frame rate during the non-drawing period in evaluating the UI smoothness 118. By considering the drawing percent 116 to determine the smoothness 118, the performance of the UI within different time periods may be more comprehensively understood, thereby more accurately evaluating the smoothness 118.

In this way, the drawing percent is taken as a weight factor, and the contribution of the frame rate during the drawing period and the non-drawing period to the overall smoothness is considered through the drawing percent, which provides a more comprehensive perspective for smoothness evaluation, so that the overall frame rate during the application running process may be more accurately reflected, and the accuracy of smoothness evaluation is improved.

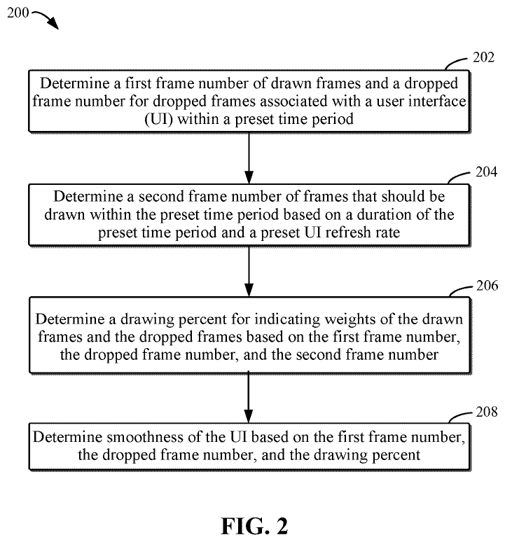

FIG. 2 shows a flowchart of a method 200 for determining smoothness according to some embodiments of the present disclosure. The method 200 may be performed by a client. The method 200 includes a block 202, a block 204, a block 206, and a block 208.

As shown in FIG. 2, at the block 202, a first frame number of drawn frames and a dropped frame number for dropped frames associated with a user interface (UI) within a preset time period are determined. Referring to FIG. 1, the client may collect drawing information of each drawn frame in the preset time period 102, and the drawing information may include information stored in a CPU or a GPU, such as a drawing period, a drawing duration, and a drawing time point, and then determine a frame number of drawn frames 110 (also referred to as a first frame number) and the dropped frame number 112 based on the information of each drawn frame. The frame number of drawn frames 110 may be determined by counting the number of drawing periods, and one drawing period corresponds to one drawn frame. In the embodiment of the present disclosure, the dropped frame number 112 may be determined according to the drawing duration of each drawn frame. For example, the drawing duration of each drawn frame is compared with a time threshold corresponding to the UI refresh rate, and the dropped frame number 112 is counted based on a comparison result. Certainly, the dropped frame number 112 may also be determined based on a load of the GPU or a central processing unit (CPU), an analysis of a rendering pipeline, or user feedback data. And a specific method for determining the dropped frame number 112 may be selected according to actual needs, which is not limited in the present disclosure.

At the block 204, a second frame number of frames that should be drawn within a preset time period is determined based on a duration of the preset time period and a preset UI refresh rate. Referring to FIG. 1, the total frame number 114 (also referred to as a second frame number) may be determined according to the duration of the preset time period 102 and a set UI refresh rate. For example, the UI refresh rate is 60, that is, 60 frames will be displayed on the UI within 1s, and the duration of the preset time period 102 is 2s, then the total frame number 114 is 120 frames. The total frame number 114 indicates the maximum number of frames that may be displayed within the duration of the preset time period 102, that is, the maximum number of frames that should be drawn theoretically.

At the block 206, a drawing percent for indicating weights of the drawn frames and the dropped frames is determined based on the first fame number, the dropped frame number, and the second frame number. Referring to FIG. 1, after the frame number of drawn frames 110, the dropped frame number 112, and the total frame number 114 are determined, the drawing percent 116 may be determined, and the drawing percent 116 may measure the weight of the frame number of drawn frames 110, that is, the fame number of successfully drawn frames and the dropped frame number 112 in the total frame number 114. Through the drawing percent 116, the influence of the frame rate during the drawing period on the overall frame rate may be measured, that is, the drawing percent 116 may help distinguish the importance of the frame rate during the drawing period and the frame rate during the non-drawing period in evaluating the UI smoothness 118.

At the block 208, the smoothness of the UI is determined based on the first frame number, the dropped frame number, and the drawing percent. Referring to FIG. 1, the smoothness 118 may be determined based on the drawing percent 116, the frame number of drawn frames 110, and the dropped frame number 112. When the value of the drawing percent 116 is high, the weight of the frame number of drawn frames 110 and the weight of the dropped frame number 112 in measuring the smoothness 118 may be increased. When the value of the drawing percent 116 is low, the influence of the dropped frame number 112 on the smoothness 118 may be weakened, and the smoothness consistent with the actual situation may be obtained.

In this way, not only the frame rate during the drawing task, but also the frame rate during the non-drawing period is considered by introducing the drawing percent, so that the overall frame rate during the application running process may be reflected more comprehensively and accurately, and the accuracy of smoothness evaluation is improved.

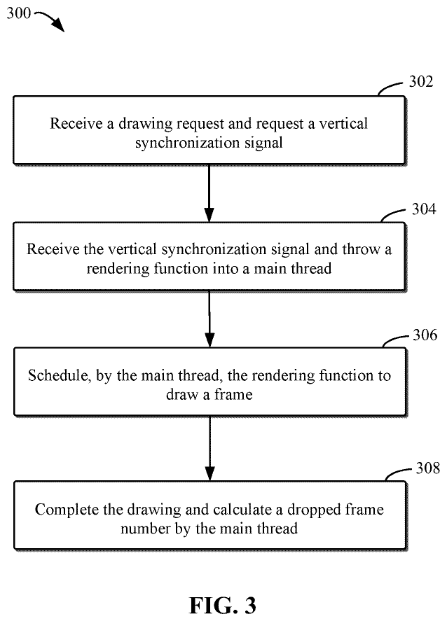

FIG. 3 shows a flowchart of a method 300 for calculating the dropped frame number according to some embodiments of the present disclosure. The method 300 may be performed by the client. At a block 302, a drawing request is received, and a vertical synchronization signal is requested. In some embodiments, the drawing request may be received by the system. The drawing request may be triggered by a user's interactive action, such as sliding the screen or tapping a button, or may be triggered by a timing mechanism inside the system to prompt the picture to be refreshed periodically. After the system receives the drawing request, a vsync signal may be sent by a display to trigger the GPU to draw a new frame. At a block 304, the vertical synchronization signal is received, and a rendering function is thrown into a main thread. After receiving the vsync signal, the CPU triggers the execution of the rendering function (doframe), and the rendering function may include all necessary drawing logic and information. Throwing the rendering function “into the main thread” here means adding the rendering function to an execution queue of the main thread and waiting for scheduling execution thereof.

At a block 306, the main thread schedules the rendering function to draw a frame. The main thread takes on the task of scheduling and executing the rendering function. During the execution of the rendering function, the GPU will draw to the UI according to the drawing logic and information. At a block 308, the drawing is completed and the dropped frame number is calculated by the main thread. The dropped frame number may be determined based on the drawing duration of each drawn frame, a load of the GPU or a central processing unit (CPU), an analysis of a rendering pipeline, or user feedback data, and a specific method for determining the dropped frame number 112 may be selected according to actual needs, which is not limited in the present disclosure.

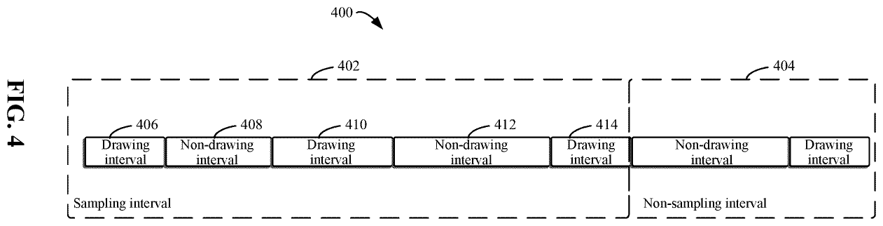

FIG. 4 shows a schematic diagram of a sampling interval 400 according to some embodiments of the present disclosure. As shown in FIG. 4, the sampling interval 402 includes a drawing interval 406, a drawing interval 410, and a drawing interval 414, and the sampling interval 402 is equivalent to the preset time period 102 in FIG. 1. The sampling interval 402 only represents a part of a GPU drawing process, and a GPU drawing interval may further include a non-sampling interval 404. In the embodiment of the present disclosure, the GPU may draw the drawn frame 104, the drawn frame 106, and the drawn frame 108 in the drawing interval 406, the drawing interval 410, and the drawing interval 414, respectively. The non-sampling interval 408 corresponds to the time interval between the drawn frame 104 and the drawn frame 106, and the non-sampling interval 412 corresponds to the time interval between the drawn frame 106 and the drawn frame 108. In both the non-sampling interval 408 and the non-sampling interval 412, the UI may display the same picture as the previously displayed drawn frame, and the specific situation is consistent with FIG. 1, which will not be repeated here.

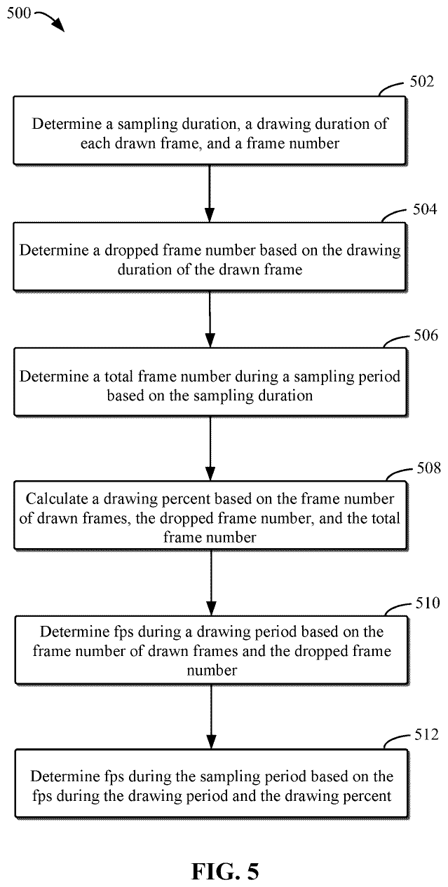

FIG. 5 shows a flowchart of a method 500 for determining fps during a sampling period according to some embodiments of the present disclosure. At a block 502, a sampling duration, a drawing duration of each drawn frame, and a frame number are determined. For example, as shown in FIG. 1, the duration of the preset time period 102 (also referred to as a sampling duration), the duration of each drawn frame in the preset time period 102, and the frame number of drawn frames 110 may be determined. The sampling duration may be set in advance, and the drawing duration of each drawn frame and the frame number of drawn frames 110 may be directly obtained from the CPU or the GPU. At a block 504, the dropped frame number is determined based on the drawing duration of the drawn frame. In some embodiments, the dropped frame number drop_sum may be determined according to formula (1):

$$drop\_sum = {\sum }_{i = 0}^{n - 1} \frac{{C}_{i}}{1000} fr \qquad ( 1 )$$

where drop_sum represents the dropped frame number, n represents the frame number of drawn frames, ci represents the drawing duration, and fr represents the UI refresh rate. In the embodiment of the present disclosure, the UI refresh rate fr may be set to 60, that is, the UI needs to be updated with 60 frames per second, which means that the drawing duration of each frame should be within 16.6 ms. In formula (1), when the drawing duration ci is greater than the ratio of 1000 to the UI refresh rate fr, that is, the drawing duration ci is greater than 16.6 ms, the dropped frame number drop_sum is 1, and when ci is less than the ratio of 1000 to the UI refresh rate fr, the dropped frame number drop_sum is 0.

At the block 506, a total frame number of frames during the sampling period is determined based on the sampling duration. Referring to FIG. 1, the total frame number of frames 114 may be determined according to the duration of the preset time period 102 (also referred to as the sampling duration) and a set UI refresh rate. For example, the UI refresh rate is 60, that is, 60 frames will be displayed on the UI within 1s, and the duration of the preset time period 102 is 2s, then the total frame number 114 is 120 frames. In some embodiments, the total frame number total_count may be determined according to formula (2):

$$total\_count = \frac{fr \times t}{1000} . \qquad ( 2 )$$

At the block 508, a drawing percent is determined based on the frame number of drawn frames, the dropped frame number, and the total frame number. In some embodiments, the sum (also referred to as a third frame number) of the fame number of drawn frames and the dropped frame number is determined first, and then a ratio of the third frame number to the total frame number is determined as the drawing percent draw_percent:

$$draw\_percet = \frac{n + drop\_sum}{total\_count} \times 100 \% \qquad ( 3 )$$

At the block 510, fps during the drawing period is determined based on the frame number of drawn frames and the dropped frame number. In some embodiments, a presentation rate of the drawn frames during the drawing period may be determined based on the ratio of the frame number of drawn frames n to the third frame number, and then the fps during the drawing period (also referred to as first fps) is determined based on the presentation rate during the drawing period and the UI refresh rate. The fps draw_fps during the drawing period may be determined according to formula (4):

$$draw\_fps = \frac{n \times fr}{n + drop\_sum} \qquad ( 4 )$$

At the block 512, the fps during the sampling period is determined based on the fps during the drawing period and the drawing percent. In some embodiments, weighted processing may be performed on the fps draw_fps during the drawing period and the fps during the non-drawing period (also referred to as third fps) based on the drawing percent draw_percent, and then the fps (also referred to as second fps) during the sampling period is determined based on the weighted first fps and the weighted third fps. The fps sampled_fps during the sampling period may be determined according to formula (5):

$$sampled\_fps = ( draw\_fps - fr ) \times draw\_percent + fr \qquad ( 5 )$$

In this way, the smoothness measurement indicator, that is, the fps sampled_fps during the sampling period, is not affected by the number of drawings, and the fps during both the drawing period and the non-drawing period may be considered, so that the actual smoothness may be more truly reflected. For example, a precondition that drawing is performed three times within 1s is set, where the drawing duration of one time is 20 ms, and the drawing durations of two times are each 10 ms, and only the drawing duration of one time exceeds 16.6 ms. It may be learned from the above that the dropped frame number is 1. It may be derived according to formula (1) to formula (5) that the drawing percent draw_percent is 6.7%, the ratio of the dropped frame number drop_sum to the total frame number total_count is 1.6%, and the fps sampled_fps during the sampling period is 59. After the two drawings of 10 ms are removed, the dropped frame number is still 1, the drawing percent draw_percent is 3.3%, the ratio of the dropped frame number drop_sum to the total frame number total_count remains unchanged, and the fps sampled_fps during the sampling period also remains unchanged.

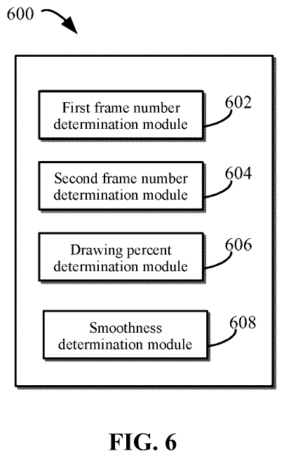

FIG. 6 shows a block diagram of an apparatus 600 for determining smoothness according to some embodiments of the present disclosure. As shown in FIG. 6, the apparatus 600 includes a first frame number determination module 602 configured to determine a first frame number of drawn frames and a dropped frame number for dropped frames associated with a user interface (UI) within a preset time period. The apparatus 600 further includes a second frame number determination module 604 configured to determine a second frame number that should be drawn within the preset time period based on a duration of the preset time period and a preset UI refresh rate. The apparatus 600 further includes a drawing percent determination module 606 configured to determine a drawing percent for indicating weights of the drawn frames and the dropped frames based on the first frame number, the dropped frame number, and the second frame number. In addition, the apparatus 600 further includes a smoothness determination module 608 configured to determine smoothness of the UI based on the first frame number, the dropped frame number, and the drawing percent.

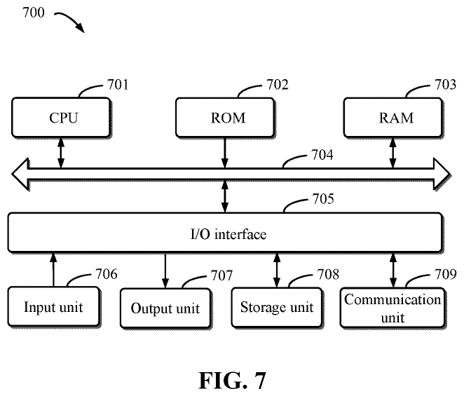

FIG. 7 shows a block diagram of a device 700 capable of implementing multiple embodiments of the present disclosure. As shown in FIG. 7, the device 700 includes a central processing unit (CPU) and/or a graphics processing unit (GPU) 701, which may perform various appropriate actions and processing according to computer program instructions stored in a read-only memory (ROM) 702 or computer program instructions loaded from a storage unit 708 into a random access memory (RAM) 703. In the RAM 703, various programs and data required for the operation of the device 700 may also be stored. The CPU/GPU 701, the ROM 702, and the RAM 703 are connected to each other through a bus 704. An input/output (I/O) interface 705 is also connected to the bus 704. Although not shown in FIG. 7, the device 700 may further include a coprocessor.

Multiple components in the device 700 are connected to the I/O interface 705, and the components include: an input unit 706, such as a keyboard, a mouse, etc.; an output unit 707, such as various types of displays, speakers, etc.; the storage unit 708, such as a magnetic disk, an optical disc, etc.; and a communication unit 709, such as a network card, a modem, a wireless communication transceiver, etc. The communication unit 709 allows the device 700 to exchange information/data with other devices through a computer network such as the Internet and/or various telecommunication networks.

The various methods or processes described above may be performed by the CPU/GPU 701. For example, in some embodiments, the method may be implemented as a computer software program, which is tangibly contained in a machine-readable medium, such as the storage unit 708. In some embodiments, a portion or an entirety of the computer program may be loaded and/or installed into the device 700 via the ROM 702 and/or the communication unit 709. When the computer program is loaded into the RAM 703 and executed by the CPU/GPU 701, one or more steps or actions in the method or process described above may be performed.

In some embodiments, the methods and processes described above may be implemented as a computer program product. The computer program product may include a computer-readable storage medium having computer-readable program instructions thereon for performing various aspects of the present disclosure.

The computer-readable storage medium may be a tangible device that may hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanically encoded device, such as a punch card or a raised structure in a groove having instructions stored thereon, and any suitable combination of the foregoing. The computer-readable storage medium used herein is not interpreted as an instantaneous signal itself, such as a radio wave or other freely propagating electromagnetic waves, electromagnetic waves propagating through a waveguide or other transmission media (for example, light pulses through an optical fiber cable), or electrical signals transmitted through wires.

The computer-readable program instructions described herein may be downloaded from the computer-readable storage medium to various computing/processing devices, or downloaded to an external computer or an external storage device through a network, such as the Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, including an object-oriented programming language and a conventional procedural programming language. The computer-readable program instructions may be executed entirely on a user computer, partly on the user computer, as a stand-alone software package, partly on the user computer and partly on a remote computer, or entirely on the remote computer or a server. In the case of involving the remote computer, the remote computer may be connected to the user computer through any kind of network, including a local area network (LAN) or a wide area network (WAN), or it may be connected to an external computer (for example, connected by using Internet provided by an Internet service provider). In some embodiments, by using the state information of the computer-readable program instructions to customize an electronic circuit, such as a programmable logic circuit, a field programmable gate array (FPGA) or a programmable logic array (PLA), the electronic circuit may execute the computer-readable program instructions, thereby implementing various aspects of the present disclosure.

These computer-readable program instructions may be provided to a processing unit of a general-purpose computer, a special-purpose computer, or other programmable data processing apparatus to produce a machine, so that these instructions, when executed by the processing unit of the computer or other programmable data processing apparatus, produce an apparatus for implementing a function/action specified in one or more blocks in the flowcharts and/or block diagrams. These computer-readable program instructions may also be stored in the computer-readable storage medium, these instructions make the computer, the programmable data processing apparatus, and/or other devices work in a specific manner, and thus, the computer-readable medium having the instructions stored thereon includes a manufactured product, which includes instructions for implementing various aspects of the function/action specified in one or more blocks in the flowcharts and/or block diagrams.

The computer-readable program instructions may also be loaded onto a computer, other programmable data processing apparatus, or other devices, so that a series of operation steps are performed on the computer, other programmable data processing apparatus, or other devices to produce a computer-implemented process, thereby enabling the instructions executed on the computer, other programmable data processing apparatus, or other devices to implement the function/action specified in one or more blocks in the flowcharts and/or block diagrams.

The flowcharts and block diagrams in the drawings show the possibly implemented architectures, functions, and operations of the device, the method, and the computer program product according to multiple embodiments of the present disclosure. In this regard, each block in the flowchart or block diagram may represent a module, program segment, or part of an instruction, and the module, program segment, or part of an instruction contains one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a special-purpose hardware-based system that executes a specified function or action, or may be implemented by a combination of special-purpose hardware and computer instructions.

The embodiments of the present disclosure have been described above, and the above description is exemplary, non-exhaustive, and not limited to the disclosed embodiments. Without departing from the scope and spirit of the illustrated embodiments, many modifications and changes will be apparent to those of ordinary skill in the art. The terms used herein are selected to best explain the principles of the embodiments, the actual applications or technical improvements to the technologies in the market, or to enable other ordinary skilled in the art to understand the embodiments disclosed herein.

Some example implementations of the present disclosure are listed below.

Example 1. A method for determining smoothness, including:
determining a first frame number of drawn frames and a dropped frame number for dropped frames associated with a user interface (UI) within a preset time period;
determining a second frame number of frames that should be drawn within the preset time period based on a duration of the preset time period and a preset UI refresh rate;
determining a drawing percent for indicating weights of the drawn frames and the dropped frames based on the first frame number, the dropped frame number, and the second frame number; and
determining smoothness of the UI based on the first frame number, the dropped frame number, and the drawing percent.

Example 2. The method of Example 1, where determining the first frame number of drawn frames for the UI and the dropped frame number for the dropped frames within the preset time period includes:
for a drawn frame within the preset time period, obtaining a drawing duration;
for the drawn frame within the preset time period, determining whether the drawing duration satisfies a preset condition associated with the UI refresh rate;
determining, in response to the drawing duration not satisfying the preset condition, that a corresponding dropped frame exists the drawn frame that do not satisfy the preset condition; and
determining the dropped frame number for the dropped frames based on the dropped frame.

Example 3. The method of any one of Examples 1-2, where determining whether the drawing duration satisfies the preset condition associated with the UI refresh rate includes:
determining a threshold for the drawing duration based on the UI refresh rate;
determining whether the drawing duration is less than or equal to the threshold;
determining, in response to the drawing duration being less than or equal to the threshold, that the drawing duration satisfies the preset condition; and
determining, in response to the drawing duration being greater than the threshold, that the drawing duration does not satisfy the preset condition.

Example 4. The method of any one of Examples 1-3, where determining the second frame number of frames that should be drawn within the preset time period includes:
determining a threshold for a drawing duration of the drawn frames based on the UI refresh rate; and
determining the second frame number based on a ratio of the duration of the preset time period to the threshold.

Example 5. The method of any one of Examples 1-4, where determining the drawing percent for indicating the weights of the drawn frames and the dropped frames includes:
determining a sum of the first frame number and the dropped frame number as a third frame number; and
determining the drawing percent based on a ratio of the third frame number to the second frame number.

Example 6. The method of any one of Examples 1-5, where determining the smoothness of the UI includes:
determining a first frames per second (fps) during a drawing period of the drawn frames based on the first frame number and the dropped frame number;
determining a second fps of the preset time period based on the first fps and the drawing percent; and
determining the smoothness of the UI based on the second fps.

Example 7. The method of any one of Examples 1-6, where determining the first fps during the drawing period of the drawn frames includes:
determining a presentation rate of the drawn frames during the drawing period based on a ratio of the first frame number to the third frame number; and
determining the first fps during the drawing period based on the presentation rate during the drawing period and the UI refresh rate.

Example 8. The method of any one of Examples 1-7, the preset time period including the drawing period and a non-drawing period, where determining the second fps of the preset time period includes:
performing weighted processing on the first fps during the drawing period and a third fps during the non-drawing period based on the drawing percent; and
determining the second fps of the preset time period based on the weighted first fps and the weighted third fps.

Example 9. The method of any one of Examples 1-8, further including:
setting the third fps to the UI refresh rate.

Example 10. An apparatus for determining smoothness, including:
a first frame number determination module configured to determine a first frame number of drawn frames and a dropped frame number for dropped frames associated with a user interface (UI) within a preset time period;
a second frame number determination module configured to determine a second frame number of frames that should be drawn within the preset time period based on a duration of the preset time period and a preset UI refresh rate;
a drawing percent determination module configured to determine a drawing percent for indicating weights of the drawn frames and the dropped frames based on the first frame number, the dropped frame number, and the second frame number; and
a smoothness determination module configured to determine smoothness of the UI based on the first frame number, the dropped frame number, and the drawing percent.

Example 11. The apparatus of Example 10, where the first frame number determination module includes:
a drawing duration obtaining module configured to, for the drawn frame within the preset time period, obtain a drawing duration;
a first determination module configured to, for the drawn frame within the preset time period, determine whether the drawing duration satisfies a preset condition associated with the UI refresh rate;
a dropped frame determination module configured to determine, in response to the drawing duration not satisfying the preset condition, that a corresponding dropped frame exists for the drawn frame that do not satisfy the preset condition; and
a dropped frame number determination module configured to determine the dropped frame number for the dropped frames based on the dropped frames.

Example 12. The apparatus of any one of Examples 10-11, where the first determination module includes:
a first threshold determination module configured to determine a threshold for the drawing duration based on the UI refresh rate;
a second determination module configured to determine whether the drawing duration is less than or equal to the threshold;
a third determination module configured to determine, in response to the drawing duration being less than or equal to the threshold, that the drawing duration satisfies the preset condition; and
a fourth determination module configured to determine, in response to the drawing duration being greater than the threshold, that the drawing duration does not satisfy the preset condition.

Example 13. The apparatus of any one of Examples 10-12, wherein the second frame number determination module includes:
a second threshold determination module configured to determine a threshold for a drawing duration of the drawn frames based on the UI refresh rate; and
a fifth determination module configured to determine the second frame number based on a ratio of the duration of the preset time period to the threshold.

Example 14. The apparatus of any one of Examples 10-13, wherein the drawing percent determination module includes:
a third frame number determination module configured to determine a sum of the first frame number and the dropped frame number as a third frame number; and
a sixth determination module configured to determine the drawing percent based on a ratio of the third frame number to the second frame number.

Example 15. The apparatus of any one of Examples 10-14, wherein the smoothness determination module includes:
a first fps determination module configured to determine a first frames per second (fps) during a drawing period of the drawn frames based on the first frame number and the dropped frame number;
a second fps determination module configured to determine a second fps of the preset time period based on the first fps and the drawing percent; and
a seventh determination module configured to determine the smoothness of the UI based on the second fps.

Example 16. The apparatus of any one of Examples 10-15, wherein the first fps determination module includes:
a presentation rate determination module configured to determine a presentation rate of the drawn frames during the drawing period based on a ratio of the first frame number to the third frame number; and
an eighth determination module configured to determine the first fps during the drawing period based on the presentation rate during the drawing period and the UI refresh rate.

Example 17. The apparatus of any one of Examples 10-16, the preset time period including a drawing period and a non-drawing period, wherein the second fps determination module includes:
a weighted processing module configured to perform weighted processing on the first fps during the drawing period and a third fps during the non-drawing period based on the drawing percent; and
a ninth determination module configured to determine the second fps of the preset time period based on the weighted first fps and the weighted third fps.

Example 18. The apparatus of any one of Examples 10-17, further including:
a setting module configured to set the third fps to the UI refresh rate.

Example 19. An electronic device, including:
a processor; and
a memory coupled with the processor, the memory having instructions stored therein, the instructions, when executed by the processor, causing the electronic device to perform actions including:
determining a first frame number of drawn frames and a dropped frame number associated with a user interface (UI) for dropped frames within a preset time period;
determining a second frame number of frames that should be drawn within the preset time period based on a duration of the preset time period and a preset UI refresh rate;
determining a drawing percent for indicating weights of the drawn frames and the dropped frames based on the first frame number, the dropped frame number, and the second frame number; and
determining smoothness of the UI based on the first frame number, the dropped frame number, and the drawing percent.

Example 20. The electronic device of Example 19, wherein determining the first frame number of drawn frames for the UI and the dropped frame number for the dropped frames within the preset time period includes:
for a drawn frame within the preset time period, obtaining a drawing duration;
for the drawn frame within the preset time period, determining whether the drawing duration satisfies a preset condition associated with the UI refresh rate;
determining, in response to the drawing duration not satisfying the preset condition, that a corresponding dropped frame exists for the drawn frame that do not satisfy the preset condition; and
determining the dropped frame number for the dropped frames based on the dropped frame.

Example 21. The electronic device of any one of Examples 19-20, where determining whether the drawing durations satisfies the preset condition associated with the UI refresh rate includes:
determining a threshold for the drawing duration based on the UI refresh rate;
determining whether the drawing duration is less than or equal to the threshold;
determining, in response to the drawing duration being less than or equal to the threshold, that the drawing duration satisfies the preset condition; and
determining, in response to the drawing duration being greater than the threshold, that the drawing duration does not satisfy the preset condition.

Example 22. The electronic device of any one of Examples 19-21, where determining the second frame number of frames that should be drawn within the preset time period includes:
determining a threshold for a drawing duration of the drawn frame based on the UI refresh rate; and
determining the second frame number based on a ratio of the duration of the preset time period to the threshold.

Example 23. The electronic device of any one of Examples 19-22, where determining the drawing percent for indicating the weights of the drawn frames and the dropped frames includes:
determining a sum of the first frame number and the dropped frame number as a third frame number; and
determining the drawing percent based on a ratio of the third frame number to the second frame number.

Example 24. The electronic device of any one of Examples 19-23, where determining the smoothness of the UI includes:
determining a first frames per second (fps) during a drawing period of the drawn frames based on the first frame number and the dropped frame number;
determining a second fps of the preset time period based on the first fps and the drawing percent; and
determining the smoothness of the UI based on the second fps.

Example 25. The electronic device of any one of Examples 19-24, where determining the first fps during the drawing period of the drawn frames includes:
determining a presentation rate of the drawn frames during the drawing period based on a ratio of the first frame number to the third frame number; and
determining the first fps during the drawing period based on the presentation rate during the drawing period and the UI refresh rate.

Example 26. The electronic device of any one of Examples 19-25, the preset time period including a drawing period and a non-drawing period, where determining the second fps of the preset time period includes:
performing weighted processing on the first fps during the drawing period and a third fps during the non-drawing period based on the drawing percent; and
determining the second fps of the preset time period based on the weighted first fps and the weighted third fps.

Example 27. The electronic device of any one of Examples 19-26, further including:
setting the third fps to the UI refresh rate.

Example 28. A computer-readable storage medium having computer-executable instructions stored thereon, wherein the computer-executable instructions are executed by a processor to implement the method of any one of Examples 1-9.

Example 29. A computer program product tangibly stored on a computer-readable medium and including computer-executable instructions that, when executed by a device, cause the device to perform the method of any one of Examples 1-9.

Although the present disclosure has been described in language specific to structural features and/or logical actions of the method, it should be understood that the subject matter defined in the appended claims is not necessarily limited to the specific features or actions described above. On the contrary, the specific features and actions described above are merely exemplary forms of implementing the claims.

I/We claim:

1. A method for determining smoothness, comprising:
determining a first frame number of drawn frames and a dropped frame number for dropped frames associated with a user interface (UI) within a preset time period;
determining a second frame number of frames that should be drawn within the preset time period based on a duration of the preset time period and a preset UI refresh rate;
determining a drawing percent for indicating weights of the drawn frames and the dropped frames based on the first frame number, the dropped frame number, and the second frame number; and
determining smoothness of the UI based on the first frame number, the dropped frame number, and the drawing percent.

2. The method of claim 1, wherein determining the first frame number of drawn frames for the UI and the dropped frame number for the dropped frames within the preset time period comprises:
for a drawn frame within the preset time period, obtaining a drawing duration;
for the drawn frame within the preset time period, determining whether the drawing duration satisfies a preset condition associated with the UI refresh rate;
determining, in response to the drawing duration not satisfying the preset condition, that a corresponding dropped frame exists for the drawn frame that do not satisfy the preset condition; and
determining the dropped frame number for the dropped frames based on the dropped frame.

3. The method of claim 2, wherein determining whether the drawing duration satisfies the preset condition associated with the UI refresh rate comprises:
determining a threshold for the drawing duration based on the UI refresh rate;
determining whether the drawing duration is less than or equal to the threshold;
determining, in response to the drawing duration being less than or equal to the threshold, that the drawing duration satisfies the preset condition; and
determining, in response to the drawing duration being greater than the threshold, that the drawing duration does not satisfy the preset condition.

4. The method of claim 1, wherein determining the second frame number of frames that should be drawn within the preset time period comprises:
determining a threshold for a drawing duration of the drawn frames based on the UI refresh rate; and
determining the second frame number based on a ratio of the duration of the preset time period to the threshold.

5. The method of claim 4, wherein determining the drawing percent for indicating the weights of the drawn frames and the dropped frames comprises:
determining a sum of the first frame number and the dropped frame number as a third frame number; and
determining the drawing percent based on a ratio of the third frame number to the second frame number.

6. The method of claim 5, wherein determining the smoothness of the UI comprises:
determining a first frames per second (fps) during a drawing period of the drawn frames based on the first frame number and the dropped frame number;
determining a second fps of the preset time period based on the first fps and the drawing percent; and
determining the smoothness of the UI based on the second fps.

7. The method of claim 6, wherein determining the first fps during the drawing period of the drawn frames comprises:
determining a presentation rate of the drawn frames during the drawing period based on a ratio of the first frame number to the third frame number; and
determining the first fps during the drawing period based on the presentation rate during the drawing period and the UI refresh rate.

8. The method of claim 7, the preset time period comprising the drawing period and a non-drawing period, wherein determining the second fps of the preset time period comprises:
performing weighted processing on the first fps during the drawing period and a third fps during the non-drawing period based on the drawing percent; and
determining the second fps of the preset time period based on the weighted first fps and the weighted third fps.

9. The method of claim 8, further comprising:
setting the third fps to the UI refresh rate.

10. An electronic device, comprising:
a processor; and
a memory coupled to the processor, the memory having instructions stored therein, the instructions, when executed by the processor, causing the electronic device to:
determine a first frame number of drawn frames and a dropped frame number for dropped frames associated with a user interface (UI) within a preset time period;
determine a second frame number of frames that should be drawn within the preset time period based on a duration of the preset time period and a preset UI refresh rate;
determine a drawing percent for indicating weights of the drawn frames and the dropped frames based on the first frame number, the dropped frame number, and the second frame number; and
determine smoothness of the UI based on the first frame number, the dropped frame number, and the drawing percent.

11. The electronic device according 10, wherein the instructions causing the electronic device to determine the first frame number of drawn frames for the UI and the dropped frame number for the dropped frames within the preset time period further cause the electronic device to:
for a drawn frame within the preset time period, obtain a drawing duration;
for the drawn frame within the preset time period, determine whether the drawing duration satisfies a preset condition associated with the UI refresh rate;
determine, in response to the drawing duration not satisfying the preset condition, that a corresponding dropped frame exists for the drawn frame that do not satisfy the preset condition; and
determine the dropped frame number for the dropped frames based on the dropped frame.

12. The electronic device according 11, wherein the instructions causing the electronic device to determine whether the drawing duration satisfies the preset condition associated with the UI refresh rate further cause the electronic device to:
determine a threshold for the drawing duration based on the UI refresh rate;
determine whether the drawing duration is less than or equal to the threshold;
determine, in response to the drawing duration being less than or equal to the threshold, that the drawing duration satisfies the preset condition; and
determine, in response to the drawing duration being greater than the threshold, that the drawing duration does not satisfy the preset condition.

13. The electronic device according 10, wherein the instructions causing the electronic device to determine the second frame number of frames that should be drawn within the preset time period further cause the electronic device to:
determine a threshold for a drawing duration of the drawn frames based on the UI refresh rate; and
determine the second frame number based on a ratio of the duration of the preset time period to the threshold.

14. The electronic device according 13, wherein the instructions causing the electronic device to determining the drawing percent for indicating the weights of the drawn frames and the dropped frames further cause the electronic device to:
determine a sum of the first frame number and the dropped frame number as a third frame number; and
determine the drawing percent based on a ratio of the third frame number to the second frame number.

15. The electronic device according 14, wherein the instructions causing the electronic device to determine the smoothness of the UI further cause the electronic device to:
determine a first frames per second (fps) during a drawing period of the drawn frames based on the first frame number and the dropped frame number;
determine a second fps of the preset time period based on the first fps and the drawing percent; and
determine the smoothness of the UI based on the second fps.

16. The electronic device according 15, wherein the instructions causing the electronic device to determine the first fps during the drawing period of the drawn frames further cause the electronic device to:
determine a presentation rate of the drawn frames during the drawing period based on a ratio of the first frame number to the third frame number; and
determine the first fps during the drawing period based on the presentation rate during the drawing period and the UI refresh rate.

17. The electronic device according 16, the preset time period comprising the drawing period and a non-drawing period, wherein the instructions causing the electronic device to determine the second fps of the preset time period further cause the electronic device to:
perform weighted processing on the first fps during the drawing period and a third fps during the non-drawing period based on the drawing percent; and
determine the second fps of the preset time period based on the weighted first fps and the weighted third fps.

18. The electronic device according 17, wherein the instructions further causing the electronic device to:
set the third fps to the UI refresh rate.

19. A non-transitory computer-readable storage medium having computer-executable instructions stored thereon, wherein the computer-executable instructions, when executed by a processor, cause the processor to:
determine a first frame number of drawn frames and a dropped frame number for dropped frames associated with a user interface (UI) within a preset time period;
determine a second frame number of frames that should be drawn within the preset time period based on a duration of the preset time period and a preset UI refresh rate;
determine a drawing percent for indicating weights of the drawn frames and the dropped frames based on the first frame number, the dropped frame number, and the second frame number; and
determine smoothness of the UI based on the first frame number, the dropped frame number, and the drawing percent.

20. The non-transitory computer readable storage medium according 19, wherein the instructions causing processor to determine the first frame number of drawn frames for the UI and the dropped frame number for the dropped frames within the preset time period further cause the processor to:
for a drawn frame within the preset time period, obtain a drawing duration;
for the drawn frame within the preset time period, determine whether the drawing duration satisfies a preset condition associated with the UI refresh rate;
determine, in response to the drawing duration not satisfying the preset condition, that a corresponding dropped frame exists for the drawn frame that do not satisfy the preset condition; and
determine the dropped frame number for the dropped frames based on the dropped frame.
